(19) United States
(12) Patent Application Publication
(10) Pub. No.: US 2025/0238726 A1
(43) Pub. Date: Jul. 24, 2025

(54) COMPUTING ARCHITECTURE WITH MODEL CORE AND FINE-TUNING PORTION

(71) Applicant: Taalas Inc., Toronto (CA)

(72) Inventors: Ljubisa Bajic, Toronto (CA); Lejla Bajic, North York (CA); Dragoljub Ignjatovic, North York (CA)

(21) Appl. No.: 18/986,431

(22) Filed: Dec. 18, 2024

Related U.S. Application Data
(60) Provisional application No. 63/613,041, filed on Dec. 20, 2023.

(51) Int. Cl. G06N 20/00

(52) U.S. Cl. CPC G06N 20/00

(57) ABSTRACT

Methods and systems which involve customized computing architectures are disclosed herein. A disclosed computing architecture comprises a model core and a fine-tuning portion. The model core stores a set of parameters of an ML model. The fine-tuning portion stores a set of fine-tuning values for a fine-tuned ML model. The fine-tuned ML model is a fine-tuned version of the ML model. The model core may be fixed during the fabrication of the customized computing architecture. The fine-tuning portion may be fixed after the model core is fixed. The model core may be less configurable than the fine-tuning portion. The set of parameters of the ML model may be defined during the fabrication of the computing architecture. The set of fine-tuning parameters for the fine-tuned ML model may be defined after the set of parameters of the ML model is defined.

### CROSS REFERENCE TO RELATED APPLICATION

This application claims the benefit of U.S. Provisional Patent Application No. 63/613,041, titled “Computing Architecture with Model Core and Fine-Tuning Portion,” and filed on Dec. 20, 2023, the entire content of which is incorporated by reference herein.

### TECHNICAL FIELD

This disclosure relates to a computing architecture designed to accelerate various computational tasks by modifying a small configurable portion of the same computing architecture.

### BACKGROUND

The past years have seen rapid advancements in specialized computing architectures for applications such as cryptography, cloud computing, machine learning, and other applications. The computing architectures continue to advance to serve the applications, for example, to parallelize complex computations and execute specific computations more efficiently, but the computational requirements of the applications grow at a faster pace. This results in a considerably increased demand for computational resources. For example, large machine learning (ML) models, such as a large language model (e.g., generative pre-trained transformer (GPT) model), may include hundreds of billions of trainable parameters. This requires more processing power and complexity, and, accordingly, a greater demand for high-performance hardware that allows the computing architectures to keep up with the processing needs of various applications (e.g., ML models).

### SUMMARY

To address the aforementioned shortcomings, a computing architecture and a method used to accelerate various computational tasks by modifying a small configurable portion of the same computing architecture are disclosed herein. The computing architecture includes a hard-wired model core configured to store a set of parameters of a machine learning (ML) model and a programmed fine-tuning portion configured to store a set of fine-tuning parameters for a fined-tuned ML model. The fine-tuned ML model is a fine-tuned version of the ML model. In some embodiments, the hard-wired model core includes a mask read only memory that stores the set of parameters of the ML model, and the programmed fine-tuning includes a programmable read only memory that stores the set of fine-tuning parameters for the ML model. In some embodiments, the computing architecture is a multicore processor.

In other embodiments, the computing architecture includes a model core configured to store a set of parameters of a machine learning (ML) model in a first memory, a programmed fine-tuning portion configured to store a set of fine-tuning parameters for a fine-tuned ML model in a second memory, and an inference engine configured to use the set of fine-tuning parameters for the ML model to generate an inference from the fine-tuned ML model. The fine-tuned ML model is a fine-tuned version of the ML model, and the first memory has a higher density than the second memory. In some embodiments, the inference engine is further configured to use the set of parameters for the ML model and the set of fine-tuning parameters for the ML model to generate the inference from the fine-tuned ML model. In some embodiments, the first memory is a mask read only memory, and the second memory is an electrically programmable read only memory. In some embodiments, the set of fine-tuning parameters forms a low rank adaptation adapter for the ML model, and the set of fine-tuning parameters replaces a corresponding set of parameters of the ML model in the fine-tuned ML model. In some embodiments, the computing architecture is a multicore processor.

In some embodiments, the method includes fabricating a computing architecture with a model core. The model core stores a set of parameters of a machine learning (ML) model in a first memory. The method also includes programming a fine-tuning portion of the computing architecture to form a programmed fine-tuning portion of the computing architecture. The programmed fine-tuning portion stores a set of fine-tuning parameters for a fine-tuned ML model in a second memory. The fine-tuned ML model is a fine-tuned version of the ML model. The first memory has a higher density than the second memory. In some embodiments, the first memory is a mask read only memory, and the second memory is an electrically programmable read only memory. In some embodiments, the set of fine-tuning parameters forms a low rank adaptation adapter for the ML model. The set of fine-tuning parameters replaces a corresponding set of parameters of the ML model in the fine-tuned ML model. In some embodiments, the computing architecture is a multicore processor. In some embodiments, the set of fine-tuning parameters for the ML model is used to generate an inference from the fine-tuned ML model. In some embodiments, the set of fine-tuning parameters is generated by a parameter efficient fine tuning (PEFT) routine for the model.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an exemplary diagram of an overall computing architecture, according to some embodiments.

FIG. 2 illustrates exemplary options for how an inference engine can use a model core and a fine-tuning portion to generate an inference, according to some embodiments.

FIG. 3 illustrates a flow chart for a set of methods for providing a computing architecture, according to some embodiments.

FIG. 4 illustrates a block diagram of an example computer system that can be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

While advancements in computing architectures can enhance performance and efficiency, a mismatch with the rapid growth of application demands may lead to computation process bottlenecks (e.g., memory bandwidth, I/O throughput) and increased cost, which drives innovation in both hardware and software. Methods and systems that involve customized computing architectures are disclosed herein. The computing architectures may be customized for specific computational tasks. Using the approaches disclosed herein a single computing architecture design can include a core that is used to efficiently accelerate a first computational task and a more configurable portion that may be modified to allow the architecture to accelerate a second computational task. The first and second computational tasks may be related, and the second computational task may be selected from many related computational tasks that may be accelerated using the same computing architecture design by modifying the configurable portion in different ways.

In some embodiments, the computational tasks may be related to applications that render inferences from large ML models. While these applications exhibit significant benefits, the cost of training cutting-edge large ML models can run into the range of millions of dollars, and the resulting model may be highly specialized for a given task. Therefore, the models are often retrained for a different purpose instead of retraining the model from scratch. In this context, approaches referred to as parameter efficient fine tuning (PEFT) have been developed, which allow for the targeted modification of a large ML model for a specific application without having to retrain all the parameters of the model. For example, a user could take a GPT model designed for general conversation and modify it to specialize in Chinese to English translations. Retraining with a PEFT approach is far more efficient than retraining all the parameters of the model and is orders of magnitude more efficient than training a model from scratch.

Embodiments of the computing architectures disclosed herein may be beneficially applied to the applications described above, in that the core of the computing architecture may be a model core that is associated with a model and the more configurable portion may be a fine-tuning portion that is associated with a fine-tuning approach for modifying the model for a given application. The model core typically refers to the main architecture and parameters of a pre-trained model, which encapsulates the model's learned representations and knowledge. The model may be a large parameter ML model such as a GPT model, BERT, or VIT-22B. The model core can store the parameters that define the model and/or be configured to execute the computations necessary to draw an inference from the model. The fine-tuning circuitry can store the parameters that are generated by a PEFT routine for the model, and/or be configured to execute the computations necessary for the PEFT routine, and/or be configured to execute the computations necessary to draw an inference from the fine-tuned model. Inference is the practical application of the ML model after the model is trained or fine-tuned, which includes the process of using the ML model to produce predictions based on the patterns it has learned during training or fine-tuning. For the fine-tuned model, inference refers specifically to applying the task-specific adaptations (learned during fine-tuning) to new data.

The model core may be less configurable than the fine-tuning portion. The model core may be fixed before the fine-tuning portion is fixed. In some embodiments, the model core may be a hardwired model core. The model core may be implemented in a portion of the computing architecture that is fixed at the time the computing architecture is fabricated and finalized for deployment. Fixing the characteristics of a portion of a computing architecture may be conducted in various ways such as by setting the values in a read only memory or a programmable read only memory. As used herein, the term “fabricated” refers to the point in a manufacturing process at which the computer chip(s) (e.g., silicon substrates) of the computing architecture are being operated upon in a fabrication plant, and “final test and customization” refers to the point in a manufacturing process in which the programmable read only memory of the computing architecture is being programmed and/or the firmware of the computing architecture, if any, is loaded into the computing architecture.

The fine-tuning portion may be more configurable than the hardwired model core. The fine-tuning portion may be fixed after the model core is fixed. The fine-tuning portion may be a programmable fine-tuning portion. For example, the fine-tuning portion may be programmable at the time the computing architecture is deployed and operational and have its characteristics set by a user that is operating the computing architecture, and the model core may be fixed at the time the device is fabricated and when the computing architecture is undergoing final customization before it is shipped to that user. As another example, the fine-tuning portion may be programmed at the time the computing architecture is undergoing final customization before being sent to a customer, and the model core can have its characteristics fixed at the time the computing architecture is fabricated.

In some embodiments, the parameters that are produced by a PEFT routine are stored by the fine-tuning portion, which renders some of the parameters in the model core superfluous. The computing architecture may be designed to ignore the superfluous or redundant parameters when rendering an inference from the fine-tuned model. At the time the computing architecture renders such an inference, these superfluous parameters represent wasted memory consumption of the model core. However, given the significant disparity between the space and power consumption of less configurable circuitry, the resources attributable to the superfluous parameters are relatively minor. Furthermore, fine-tuned models that are based on the same model core may be applied to a wide range of applications and share the bulk of the core model. As such, a single computing architecture design may be inexpensively modified for many different applications by the fine-tuning portion disclosed herein. This may be orders of magnitude less expensive than the cost of providing fully custom computing architectures for each of those applications regardless of the fact that the single chip design may have minor superfluous functionality.

### System Implementation

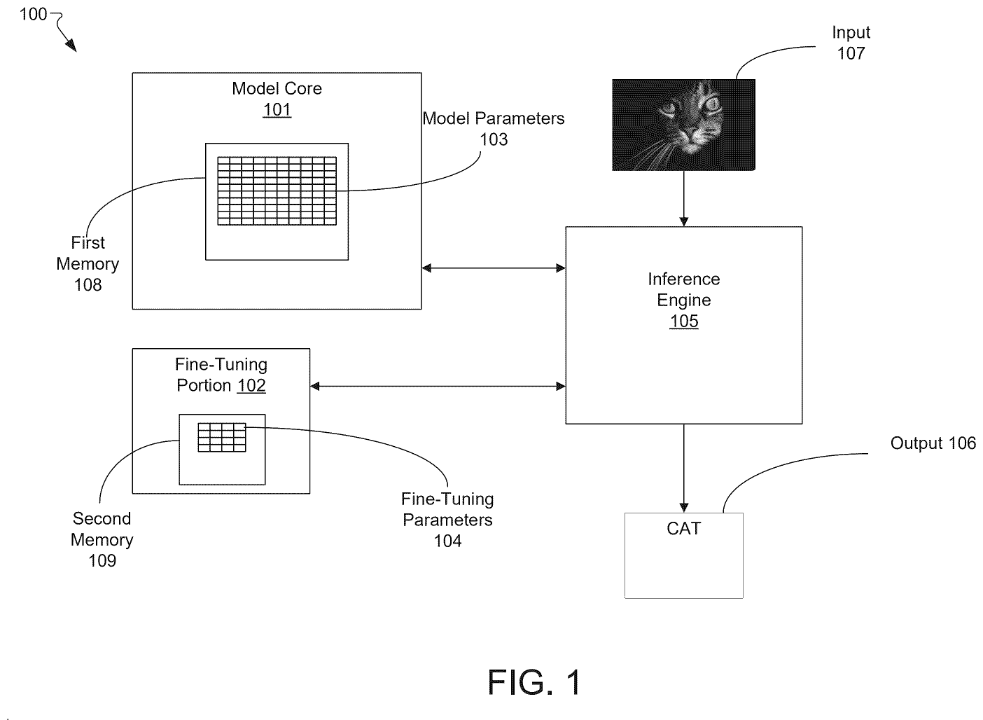

FIG. 1 illustrates an exemplary diagram of an overall computing architecture 100, according to some embodiments. Computing architecture 100 may be implemented in various ways. In some embodiments, computing architecture 100 may be a specialized architecture that is designed to accelerate a particular workload in a given application such as generating an inference from an ML model or generating a hash in accordance with a cryptographic algorithm. In other embodiments, computing architecture 100 may be implemented in a data center (e.g., in a set of servers), in an edge environment (e.g., a mobile data center), on a client device (e.g., a mobile phone or wearable device), or on an internet of things (IoT) device (e.g., a sensor). In yet other embodiments, computing architecture 100 may also be implemented on a stationary device (e.g., a base station), a mobile vehicle (e.g., an autonomous automobile), or a collection of vehicles (e.g., a swarm of autonomous drones).

In some embodiments, computing architecture 100 may be implemented by a single computing node or a collection of computing nodes operating in concert. For example, the computing architecture 100 may be implemented as a single specialized application specific integrated circuit (ASIC), a single core processor, a multicore processor, or a network of processors. Computing architecture 100 may also be implemented on a single substrate, on multiple substrates packaged together in a single package, on multiple packages on a common back plane, on one or more servers, and in one or more data centers. In other embodiments, computing architecture 100 may be implemented on multiple computing nodes, for example, multiple chiplets or on one or more wafer-scale integrated circuits.

When computing architecture 100 is implemented as a collection of computing nodes, computing architecture 100 may include a network, such as a network on chip (NoC) for a multicore processor. It should be noted that the term “NoC” is not meant to indicate that all the cores of the processor are on a single semiconductor substrate. Rather, a NoC may be implemented on various interconnected chips. The various chips may be integrated in a single package or may be in separate packages. These chips may be on different chips and networked together on a common backplane such as a printed circuit board, interposer, or silicon mesh. These chips may also be on different support structures such as different printed circuit boards or silicon meshes. The network linking the computing nodes may include a server level, rack level, and/or inter- and intra-data center levels. The network may also include any form of interconnect mesh and/or any scale from intra-chip communication to the Internet.

In FIG. 1, computing architecture 100 may include a model core 101, a fine-tuning portion 102, and an inference engine 105. The fine-tuning portion 102 may be a programmable fine-tuning portion. In some embodiments, model core 101 may store a set of parameters 103 of an ML model, and fine-tuning portion 102 may store a set of fine-tuning parameters 104 for a fine-tuned ML model. A fine-tuned ML model may be a fine-tuned version of the ML model.

In some embodiments, inference engine 105 may use model core 101 and fine-tuning portion 102 to generate an inference output 106 from an input 107. For example, inference engine 105 may generate an output 107 in the form of a class for an input image (e.g., input 107). In this case, the model being executed by inference engine 105 may be an image classifier. However, it should be noted that an inference engine 105 may execute any ML models such as large language models (LLMs), natural language processing (NLP) models, variational autoencoders (VAEs), generative adversarial networks (GANs), long short-term memories (LSTMs), recurrent neural networks (RNNs), convolutional neural networks (CNNs), transformer models, autoencoders, and/or any other ML models that are defined by a large number of parameters. In addition, the ML model does not have to be an artificial neural network. The approaches disclosed herein can also apply to reinforcement learning models and other types of models. In other embodiments, inference engine 105 may be replaced with an alternative computational engine for a different workload. The alternative computational engine may use model core 101 and fine-tuning portion 102 to execute that different workload.

In some embodiments, model core 101 may be fixed during fabrication or during the final test and customization of the customized computing architecture 100. The fine-tuning portion 102 may be fixed at a later time than when model core 101 is fixed. In some embodiments, fixing model core 101 may include setting the values of model parameters 103 in a memory of model core 101. The memory may be a first memory 108, which may be a read only memory (ROM), a one-time programmable (OTP) read only memory (PROM), an electrically programmable read only memory (EPROM), a re-programmable read only memory, an electrically erasable programmable read only memory (EEPROM), or another type of memory. Fixing the fine-tuning portion 102 may involve setting the values of fine-tuning parameters 104 in memory of the fine-tuning portion 102. The memory may be a second memory 109, which may be a ROM, an OTP PROM, PROM, a re-programmable read only memory, an EPROM, an EEPROM, a random access memory (RAM), a static random-access memory (SRAM), a dynamic random access memory (DRAM), a flash memory, or another type of memory.

As used herein, the term “fixed” refers to the point at which a circuit module has its parameters locked in such a way that these parameters are set and cannot be changed without reprogramming. For example, a laser fuse PROM is fixed as soon as it is burned in and the bits are either fused or cut. As another example, a mask ROM is fixed when the layers that define the mask ROM have been applied in the process flow of the chip. As another example, an embedded system module can be fixed as soon as the firmware has been loaded into the module by programming the non-volatile memory of the module.

As used herein, the term “fabricated” refers to the point in a manufacturing process at which the computer chip(s) (e.g., silicon substrates) of computing architecture 100 are being operated upon in a fabrication plant, and the term “final test and customization” refers to the point in a manufacturing process in which the programmable read only memory of computing architecture 100 is being programmed and/or the firmware of computing architecture 100 (if any) is loaded into the computing architecture.

The model core 101 and fine-tuning portion 102 may be fixed in various ways. For example, model core 101, implemented on a chip or chips, may be fixed during fabrication when the top layers of the chip or chips are fabricated. In this example, model parameters 103 may be stored in a mask ROM. The mask ROM can store the data in the form of different connections formed by wires that are in configurable masks of the fabrication process. The mask ROM can store the data in the form of different transistors that have been activated or not used by configurable implant masks of the fabrication process. The model core 101 that is fixed in such a manner cannot be modified after formation, for example, in the case of a mask ROM implementation or an OTP implementation. The model core 101 in such a case is referred to as a hard-wired model core. Fine-tuning portion 102 may be fixed after model core 101 is fixed. For example, if model core 101 is fixed during fabrication, fine-tuning portion 102 may be fixed during the final test and customization. As another example, if model core 101 is fixed during the final test and customization, fine-tuning portion 102 may be fixed when computing architecture 100 is deployed and in operation.

In some embodiments, model core 101 may be less configurable than fine-tuning portion 102. The model core 101 may be hard-wired and fixed during the fabrication of the device while fine-tuning portion 102 may be programmable and fixed during the final test and customization. The fine-tuning portion 102 may be fixed after fabrication, such as during OTP programming during final test and customization, which is referred to herein as a programmable fine-tuning portion. For example, model parameters 103 may be stored in a mask ROM, and fine-tuning parameters 104 may be stored in an OTP memory to which the parameters are written when computing architecture 100 is being finalized for delivery to a user. The set of parameters 103 of an ML model may be defined during the fabrication of computing architecture 100. The set of fine-tuning parameters 104 for the fine-tuned ML model may be defined during the programming of computing architecture 100.

The model parameters 103 and fine-tuning parameters 104 may take various forms. Both sets of parameters may be different data types such as 8-bit integer, 16-bit floating point, or various other data types. The sets of parameters (e.g., 103, 104) may be the same data types, or they may be different data types. In some embodiments, model parameters 103 may include all the parameters necessary to define a large ML model. For example, if the large ML model is a GPT-3 model, model parameters 103 may include all the parameters (i.e., over 150 billion parameters) that are needed to generate an inference from GPT-3. The fine-tuning parameters 104 may include parameters generated by a PEFT routine operating on model parameters 103 or some other routines used to produce parameters to fine-tune a model. The fine-tuning parameters 104 may be smaller in number than the model parameters 103.

As discussed above, fine-tuning parameters 104 may be parameters of a fine-tuned ML model, which may be a fine-tuned version of the ML model defined by model parameters 103. In some embodiments, fine-tuning parameters 104 may be selected to replace specific parameters of model core 101 or may be selected to augment the parameters of model core 101, where model core 101 stores model parameters 103. Fine-tuning parameters 104 often augment the trained ML model's parameters in two ways. Either one or more new layers (e.g., fine-tuning layers specific to a task) may be added to the ML model to adapt the ML model to the specific task, or low-rank fine-tune parameter metrics may be added in parallel with model core 101 (e.g., weight matrices of the ML model) such that input can pass through both the model core and the low-rank matrices to produce a combined output that preserves the feature of model core 101 while enhancing task-specific performance.

In some embodiments, fine-tuning portion 102 may include the data that indicates which parameters are being replaced in model parameters 103 and/or how fine-tuning parameters 104 are meant to be used to augment the model parameters 103. This data may be stored explicitly, for example, by an address of a set of parameters in model parameters 103 that will be replaced by specific fine-tuning parameters 104. The data may also be stored implicitly, for example, by storing fine-tuning parameters 104 that are meant to be used to a particular adapter at a location that is expected by the design and integration of fine-tuning portion 102 and inference engine 105.

The model core 101 and the fine-tuning portion 102 may use different types of memories to store parameters. In some embodiments, model core 101 may store a set of parameters of an ML model (e.g., model parameters 103) in the first memory 108, and fine-tuning portion 104 may store a set of fine-tuning values (e.g., fine-tuning parameters 104) for a fine-tuned ML model in the second memory 109. The first memory 108 may have a higher density than the second memory 109. In particular, first memory 108 may be a higher-density and less configurable memory while second memory 109 may be a lower-density and more configurable memory. For example, the first memory 108 may be a mask ROM, and the second memory 109 may be a flash EPROM. Accordingly, a base model (e.g., model core 101) may be stored in a high-density memory, and a large volume of chips may be produced using the base model while the fine-tuning portion 102 is modified to adapt to the base model for specific use cases. In the example of FIG. 1, the base model (e.g., model core 101) may be a general image classifier, and the fine-tuning portion (e.g., 102) can fine-tune the base model to improve its performance (e.g., in classifying black and white images).

The fine-tuning parameters 104 may be generated in various ways. In some embodiments, fine-tuning parameters 104 may be generated by a separate architecture that performs a fine-tuning routine for model parameters 103. The fine-tuning parameters 104 may then be loaded into computing architecture 100, for example, by being programmed into second memory 109 (e.g., a non-volatile flash memory). In other embodiments, fine-tuning portion 102 may include logic circuitry to perform a fine-tuning routine on the model parameters (e.g., 103) stored in model core 101. However, given the computational requirements of running standard fine-tuning routines, it will likely be more efficient to run the routines externally and load the fine-tuning parameters into fine-tuning portion 102, particularly when computing architecture 100 is implemented as a multicore processor or individual integrated circuit.

The fine-tuning routines may include adjusting model core 101 to adapt it to a specific task or dataset while minimizing the number of parameters that need to be updated to achieve better performance. This approach is particularly useful in scenarios with limited data or computational resources. The specific fine-tuning routine may vary based on the architecture of the model core, the task at hand, and/or the characteristics of the dataset. In some embodiments, a fine-tuning routine may be a PEFT routine (e.g., a Low-Rank Adaptation (LoRA) routine). The PEFT may identify sets of parameters in an ML model that need to be replaced in order to optimize the ML model for a particular application. The PEFT routine may formulate adapters that work alongside the ML model to optimize the ML model for a particular application. The PEFT routine may formulate adapters that replace portions of the ML model or the ML model as a whole, to optimize the ML model for a particular application. The PEFT routine can generally produce parameters and any ancillary data required to produce a fine-tuned ML model, where the fine-tuned ML model is a fine-tuned version of the ML model associated with model core 101.

The model core 101 and the fine-tuning portion 102 may be designed in combination with inference engine 105 to generate inferences from a fine-tuned ML model depending upon the type of fine-tuning routine(s) that is applied. For example, the elements of computing architecture 100 may be designed to replace portions of parameters 103 from model core 101 with parameters 104 from fine-tuning portion 102. Since the memory in which the model parameters 103 are stored may not be erasable, this could be conducted by modifying an address table used to access the model parameters 103 with addresses for replacement parameters 104 in the fine-tuning portion 102. As another example, the elements of computing architecture 100 may be configured to modify the instructions executed by inference engine 105 to include an adapter or substitute a portion of the fine-tuned ML model when generating an inference from the fine-tuned ML model. The inference engine 105 could be designed to execute two different graphs, one for the ML model and one for the fine-tuned ML model, using stored instructions that define the graphs via an order of operations and addresses of the required parameters for those operations.

The elements of computing-architecture 100 may also be configured to render inferences using only the original ML model if no fine-tuning routine was conducted or if it was desired to use the original model at a specific time. A specific status register in computing architecture 100 may be configured to place computing architecture 100 in a mode where the fine-tuned version of the model was to be used to generate an inference, or in a mode where the model was to be used to generate an inference. In some embodiments, the same computing architecture may be designed to operate using multiple fine-tuned versions of the model that have been fine-tuned for different applications, and the status register may be configured to determine which of those multiple fine-tuned versions should be used to generate an inference. In these embodiments, computing architecture 100 could include multiple fine-tuned portions (e.g., multiple copies of fine-tuning portion 102) that are dedicated to specific fine-tuned versions. Alternatively, the same fine-tuned portion 102 could include different memories or different sections of the same memory to store fine-tuning parameters 104 for the different fine-tuned versions and logic to select the appropriate fine-tuning parameters 104 for a given fine-tuned version.

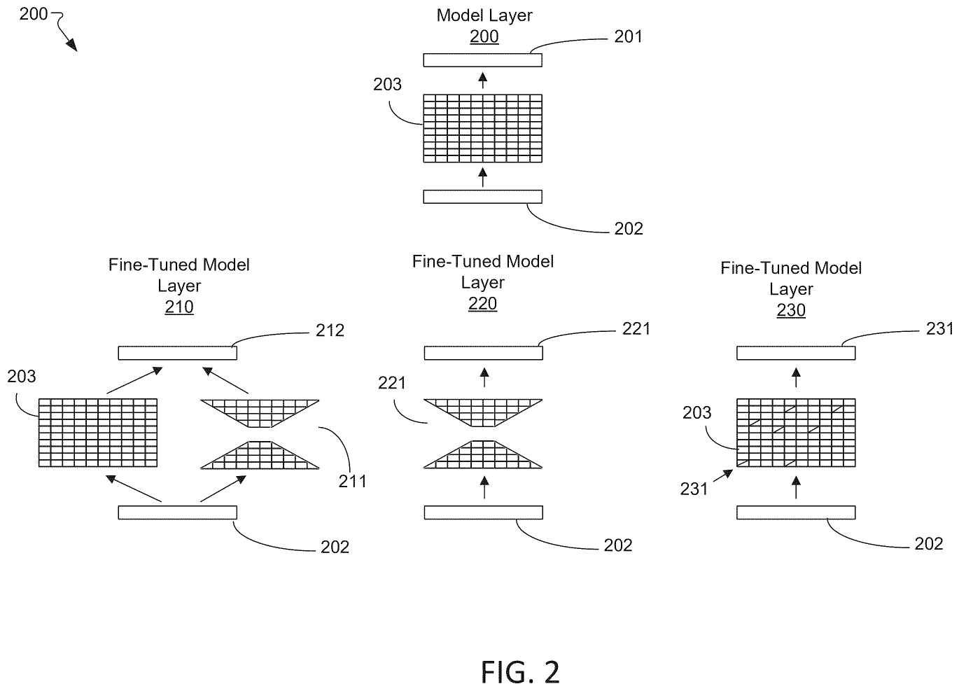

FIG. 2 illustrates various options for how an inference engine 105 can use a model core 101 and a fine-tuning portion 102 to generate an inference, according to some embodiments. Model layer 200 is an illustration of how an input 202 to an ML model may be used to generate an output 201 of the layer using a set of model parameters 203 that define the layer. Input 202 may be the output of a prior layer, and output 201 may be the input to the next layer. Variants of the ML model from which model layer 200 is taken to form fine-tuned models are described in the following paragraphs. The fine-tuning portion 102 of computing architecture 100 can store fine-tuning parameters 104 to augment or otherwise modify the ML model. Alternatively or in combination, fine-tuning parameters 104 may include logic to modify the ML model. For example, the fine-tuning portion 102 may store a set of fine-tuning parameters 104, and the set of fine-tuning parameters 104 may form a low rank adaptation adapter for the ML model, as described below in the examples of fine-tuned model layer 210 and fine-tuned model layer 220. Alternatively or in combination, the fine-tuning portion 102 may store a set of fine-tuning parameters 104, and the set of fine-tuning parameters 104 may replace a corresponding set of parameters of the ML model in the fine-tuned version of the ML model as in the example of fine-tuned model layer 230 below.

In some embodiments, the fine-tuned model may include either the whole original ML model or a portion of the original ML model along with an augmentation (e.g., an adapter). Fine-tuned model layer 210 is a layer from such a fine-tuned model. Fine-tuned model layer 210 includes a set of model parameters 203 from the original ML model along with a low rank adapter 211. Fine-tuned model layer 210 may accordingly apply the input 202 to both the set of model parameters 203 and low rank adapter 211, and then combine the outputs of both 203 and 211 to produce layer output 212. In this approach, low rank adapter 211 has far fewer parameters than the set of model parameters 203 such that retraining the model can be implemented by only modifying the parameters of low rank adapter 211, which is more efficient than retraining the whole model. In some embodiments that are in accordance with fine-tuned model layer 210, fine tuning portion 102 can store the parameters that define low rank adapter 211. Fine tuning portion 102 can also store information identifying which layers of the ML model should be augmented with the inclusion of an adapter such as low rank adapter 211. Furthermore, in some embodiments, fine-tuning portion 102 can include logic to execute the computations required to apply input 202 to low rank adapter 211. For example, inference engine 105 may be a hardwired logic system such as a systolic array that is designed to execute the ML model. Fine-tuning portion 102 can include logic to harvest layer input values (e.g., input 202) and the activations from the application of input 202 to the set of model parameters 203, apply the input to low rank adapter 211, and formulate output 212 for the next layer of the ML model. The logic, used in modifying the original ML model to produce the fine-tuned model and the parameter values, may be configurable in fine-tuning portion 102.

In some embodiments, the fine-tuned model may be a simplified replacement for the original model. For example, the simplified replacement can comprise a low rank approximation of the original model. Fine-tuned model layer 220 is a layer from such a fine-tuned model. Fine-tuned model layer 220 includes a low rank approximation 221 of a set of model parameters 203 that may be used to produce layer output 221 from input 202. In this approach, low rank approximation 221 has far fewer parameters than the set of model parameters 203 such that retraining the model can be implemented by only modifying the parameters of low rank approximation 221, which is more efficient than retraining the whole model. In embodiments that are in accordance with fine-tuned model layer 220, fine tuning portion 102 can store the parameters that define low rank approximation 221. Alternatively, fine tuning portion 102 can store the parameters that define low rank approximation 221 in combination with model core 101. For example, fine tuning portion 102 can store replacement parameters for parameters in the set of model parameters 203. Additionally or in combination, fine-tuning portion 102 can store an identification of which parameters should not be utilized from the set of model parameters 203 in order to form low rank approximation 221. Fine tuning portion 102 can also store information identifying which layers of the ML model should be augmented with the use of low rank approximation 221. Furthermore, in some embodiments, fine-tuning portion 102 can include logic to execute the computations required to apply input 202 to low rank approximation 221. For example, inference engine 105 may be a hardwired logic system such as a systolic array that is designed to execute the ML model. Fine-tuning portion 102 can include logic to harvest layer input values (e.g., input 202), apply the input to low rank approximation 221, and formulate output 221 for the next layer of the model. The logic for the manner in which the model is modified to produce the fine-tuned model, as well as the parameter values, may be configurable in fine-tuning portion 102. While the example of a low rank approximation has been used in this example, low rank approximation 221 may be replaced with any simplified version of the set of model parameters 203 that may be more easily trained than the set of model parameters 203.

In some embodiments, the fine-tuned model may include a set of fine-tuning parameters that replace a corresponding set of parameters of the ML model. Fine-tuned model layer 230 is a layer from such a fine-tuned model. Fine-tuned model layer 230 includes a set of fine-tuning parameters 231 of a set of model parameters 203 that may be used to produce layer output 231 from input 202. In FIG. 2, the set of fine-tuning parameters 231 is marked by strikes through the corresponding parameters of the ML model. In this approach, the replacement parameters are far fewer in number than the parameters of model parameters 203 such that retraining the model may be implemented by only modifying the replacement parameters, which is more efficient than retraining the whole model. In embodiments that are in accordance with fine-tuned model layer 230, fine tuning portion 102 can store the replacement parameters as well as an identification of the corresponding parameters in the set of model parameters 203 that are to be replaced. The location may be stored explicitly, for example, by identifying an address of the corresponding model parameters with reference to the structure of the set of model parameters 203 or with reference to the addresses of a memory in model core 101 in which the set of model parameters are stored (e.g., first memory 108). Alternatively, the locations may be stored implicitly, for example, by storing the values in specific locations in second memory 109 or by storing the replacement values in a data structure with the same dimensions as the set of parameters 203 such that the data structure may be used as a mask to replace the corresponding values. For example, fine tuning portion 102 can store replacement parameters for parameters in the set of model parameters 203. One benefit of this approach is that the logic required to execute the fine-tuned model will be similar to that of the logic required to execute the original model, except for the logic used to retrieve the replacement values.

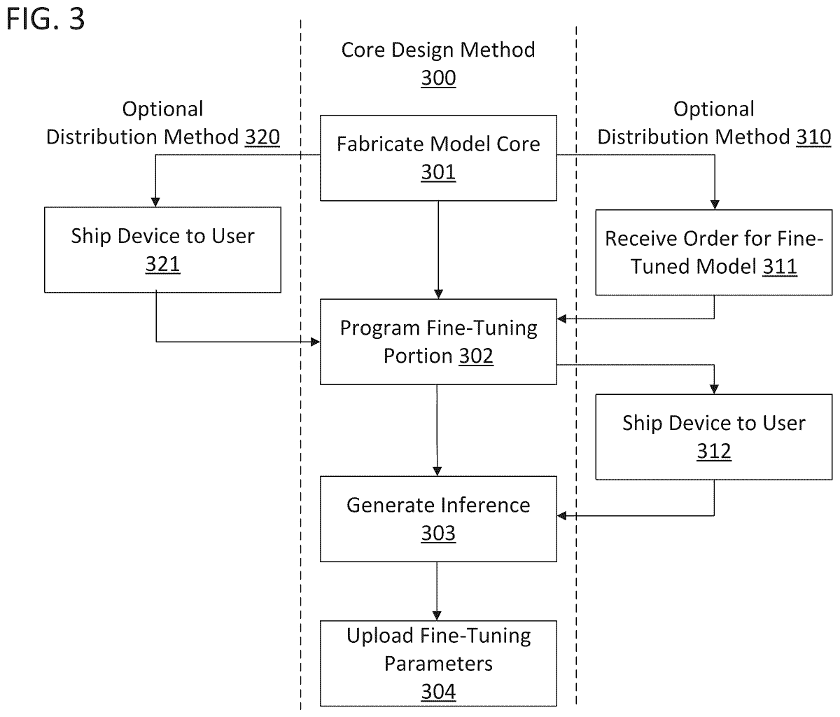

FIG. 3 illustrates a flow chart 300 for a set of methods for providing a computing architecture, according to some embodiments. In FIG. 3, a core design method 300 and two optional distribution methods 310 and 320 are described. Distribution method 310 and distribution method 320 are mutually exclusive.

Core design method 300 includes step 301 of fabricating a computing architecture with a model core, whereby a model core stores a set of parameters of an ML model in a first memory. The model core may be model core 101. The first memory may be memory 108. Core design method 300 also includes step 302 of programming a fine-tuning portion of the computing architecture, whereby a programmed fine-tuning portion of the computing architecture is formed. The fine-tuning portion may be fine-tuning portion 102. Responsive to step 301 and step 302 being implemented, the programmed fine-tuning portion can store a set of fine-tuning values for a fine-tuned ML model in a second memory. The second memory may be memory 109. The fine-tuned ML model may be a fine-tuned version of the ML model. The first memory may have a higher density than the second memory. Core design method 300 can continue with step 303, where an inference is generated using the fine-tuned version of the ML model. The fine tuning parameters (e.g., 104) determined upon the inference generation can then be uploaded onto a device shipped to a user to adapt to the computation needs of one more tasks customized by the user, as shown in step 304. The inference generation and fine tuning parameters generation are detailed below in step 321.

In some embodiments, step 301 may be conducted by a manufacturer of the computing architecture (e.g., at a fabrication facility for semiconductor chips). Steps 303 and 304 may be conducted by a user of the computing architecture after the computing architecture has been deployed for use with the fine-tuned version of the ML model. Step 302 can either be conducted by the manufacturer of the computing architecture or by the user of the computing architecture based on which distribution method is utilized.

In some embodiments, optional distribution method 320 may be applied. Distribution method 320 includes step 321 of shipping a device to a user. This step 321 may be conducted after fabricating the model core in step 301 and before programming a fine-tuning portion in step 302. Using this approach, a manufacturer can design the computing architecture with a core model and distribute the computing architecture to a user. The user can then modify the computing architecture to generate inferences for a specific application using a fine-tuned model that is specified by the user when the user conducts fine-tuning portion 302. In these embodiments, the user may be responsible for conducting the training routine necessary to modify the ML model for a given application. This approach may be beneficial in that the user will not need to provide the training data for the fine-tuning of the ML model to the manufacturer, thereby improving the security of the training data. In addition, the user and the manufacturer may benefit from a lower cost per computing architecture because a large inexpensive non-configurable core model is combined with a small, and therefore also inexpensive, configurable fine-tuning portion. Furthermore, the user in this case may not be an end user but rather a distributor that focuses on generating computing architectures for specific applications. This distribution method 320 allows both the distributor and the original manufacturer to benefit from developing specialized expertise in the distribution chain.

In some embodiments, optional distribution method 310 may be applied. Distribution method 310 includes step 311 of receiving an order for a fine-tuned model and step 312 of shipping a device to a user. Step 311 of receiving an order for the fine-tuned model 311 may be conducted after fabricating the model core in step 301. Step 312 of shipping the device to a user 312 may be conducted after step 301 of fabricating the model core and after step 302 of programming a fine-tuning portion. In these embodiments, the manufacturer may be responsible for conducting the training routine necessary to modify the ML model for a given application. This approach may be beneficial in that a manufacturer can keep an inventory of parts with a common core and can use that same core design to service many different users or different user applications by modifying a more configurable portion of the design. In these embodiments, the users may not even be aware that they are ordering the same part for different applications. Instead, all the users can see is the decreased cost associated with a large inexpensive non-configurable core model combined with a small, and therefore also inexpensive, configurable fine-tuning portion.

### ADDITIONAL CONSIDERATION

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

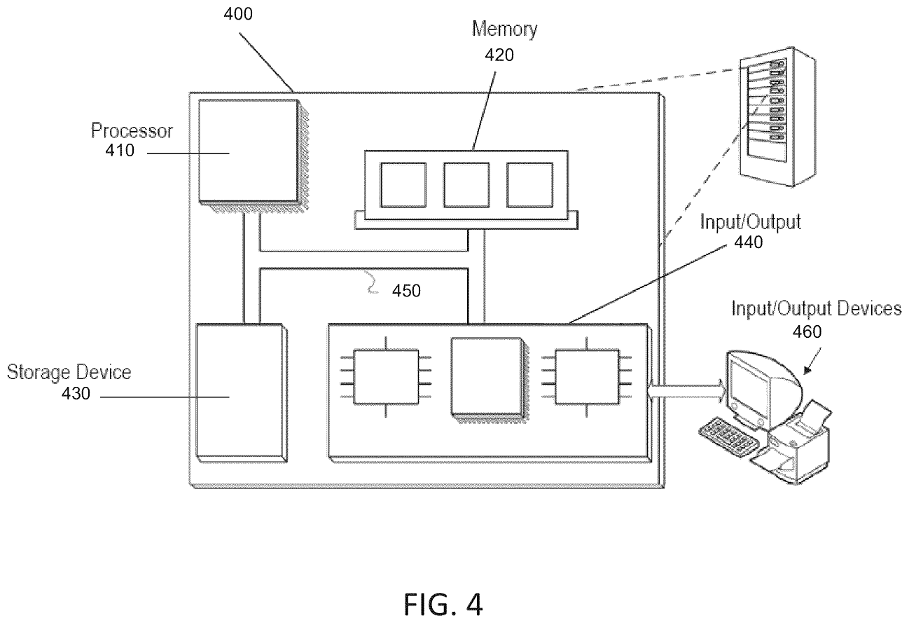

FIG. 4 is a block diagram of an example computer system 400 that may be used in implementing the technology described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 440. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-state drive, a flash drive, or some other large capacity storage device. For example, the storage device may store long-term data (e.g., database data, file system data, etc.). The input/output device 440 provides input/output operations for the system 400. In some implementations, the input/output device 440 may include one or more network interface devices, e.g., an Ethernet card, a serial communication device, e.g., an RS-232 port, and/or a wireless interface device, e.g., an 802.4 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations and processes described in this specification may be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification may be implemented as one or more computer programs, i.e., one or more modules of computer program instructions encoded on a tangible nonvolatile program carrier for execution by, or to control the operation of, data processing apparatus. Alternatively or in addition, the program instructions may be encoded on an artificially generated propagated signal, e.g., a machine-generated electrical, optical, or electromagnetic signal that is generated to encode information for transmission to suitable receiver apparatus for execution by a data processing apparatus. The computer storage medium may be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computing architecture comprising:
a hard-wired model core configured to store a set of parameters of a machine learning (ML) model; and
a programmed fine-tuning portion configured to store a set of fine-tuning parameters for a fined-tuned ML model, wherein the fine-tuned ML model is a fine-tuned version of the ML model.

2. The computing architecture of claim 1, wherein:
the hard-wired model core comprises a first memory that stores the set of parameters of the ML model, and
the programmed fine-tuning portion comprises a second memory that stores the set of fine-tuning parameters for the ML model.

3. The computing architecture of claim 2, wherein:
the first memory comprises a mask read only memory, and
the second memory comprises one or more of a static random-access memory (SRAM), a dynamic random access memory (DRAM), or other programmable read only memories.

4. The computing architecture of claim 2, wherein the first memory has a higher density than the second memory.

5. The computing architecture of claim 1, wherein the computing architecture is a multicore processor.

6. A computing architecture comprising:
a model core configured to store a set of parameters of a machine learning (ML) model in a first memory;
a programmed fine-tuning portion configured to store a set of fine-tuning parameters for a fine-tuned ML model in a second memory, wherein the fine-tuned ML model is a fine-tuned version of the ML model, and the first memory has a higher density than the second memory; and
an inference engine configured to use the set of fine-tuning parameters for the ML model to generate an inference from the fine-tuned ML model.

7. The computing architecture of claim 6, wherein the inference engine is further configured to use the set of parameters for the ML model and the set of fine-tuning parameters for the ML model to generate the inference from the fine-tuned ML model.

8. The computing architecture of claim 6, wherein:
the first memory is a mask read only memory,
the second memory is an electrically programmable read only memory, and
the electrically programmable read only memory comprises at least a static random-access memory (SRAM) or a dynamic random access memory (DRAM).

9. The computing architecture of claim 6, wherein the set of fine-tuning parameters forms a low rank adaptation adapter for the ML model.

10. The computing architecture of claim 6, wherein the set of fine-tuning parameters replaces a corresponding set of parameters of the ML model in the fine-tuned ML model.

11. The computing architecture of claim 6, wherein the computing architecture is a multicore processor.

12. A method comprising:
fabricating a computing architecture with a model core, wherein the model core stores a set of parameters of a machine learning (ML) model in a first memory; and
programming a fine-tuning portion of the computing architecture to form a programmed fine-tuning portion of the computing architecture,
wherein:
the programmed fine-tuning portion stores a set of fine-tuning parameters for a fine-tuned ML model in a second memory,
the fine-tuned ML model is a fine-tuned version of the ML model, and
the first memory has a higher density than the second memory.

13. The method of claim 12, wherein:
the first memory is a mask read only memory,
the second memory is an electrically programmable read only memory, and
the electrically programmable read only memory comprises at least a static random-access memory (SRAM) or a dynamic random access memory (DRAM).

14. The method of claim 12, wherein the set of fine-tuning parameters forms a low rank adaptation adapter for the ML model.

15. The method of claim 12, wherein the set of fine-tuning parameters replaces a corresponding set of parameters of the ML model in the fine-tuned ML model.

16. The method of claim 12, wherein the set of fine-tuning parameters are selected to augment the set of parameters of the ML model.

17. The method of claim 12, wherein the computing architecture is a multicore processor.

18. The method of claim 12, wherein the set of fine-tuning parameters is generated by a parameter efficient fine tuning (PEFT) routine for the model.

19. The method of claim 12, wherein:
the model core is implemented on at least one chip, and
the model core is fabricated before the programming of the fine-tuning portion.

20. The method of claim 10, wherein the set of fine-tuning parameters for the ML model is used to generate an inference from the fine-tuned ML model.

21. The method of claim 10, wherein a respective fine-tuned version of the ML model is fine-tuned for a respective application.

22. The method of claim 19, wherein a status register is configured to determine a version of the fine-tuned ML model used to generate an inference.
